(19) United States
(12) Patent Application Publication
(10) Pub. No.: US 2014/0059474 A1
(43) Pub. Date: Feb. 27, 2014

(54) ELECTRONIC DEVICE AND METHOD FOR CHANGING PAGE COUNT ACCORDING TO A DURATION OF INPUT TOUCH

(71) Applicant: Samsung Electronics Co., Ltd., Gyeonggi-do (KR)

(72) Inventor: Tae-Sik CHO, Seoul (KR)

(73) Assignee: Samsung Electronics Co., Ltd., Gyeonggi-do (KR)

(21) Appl. No.: 13/947,546

(22) Filed: Jul. 22, 2013

(30) Foreign Application Priority Data
Aug. 23, 2012 (KR) 10-2012-0092657

(51) Int. Cl. G06F 3/0488; G06F 3/0483

(52) U.S. Cl. CPC G06F 3/0488; G06F 3/0483
USPC 715/776

(57) ABSTRACT

An electronic device and method for navigating content to a desired a page based on a duration of touch input includes receiving a touch input at a particular region of displayed contents, counting and displaying a page to the desired page during which the touch input is in contact with the display screen, reaching and displaying the desired page when the touch input is lifted, and further turning to the page including the content according to a further gesture detected thereon.

### CLAIM OF PRIORITY

This application claims priority under 35 U.S.C. §119(a) to a Korean Patent Application filed in the Korean Intellectual Property Office on Aug. 23, 2012 and assigned Serial No. 10-2012-0092657, the contents of which are herein incorporated by reference.

### BACKGROUND

1. Field of the Invention

The present disclosure relates to an electronic device and method for changing a page count.

2. Description of the Related Art

The convenience of portable device users is being improved as they can store various multimedia contents in a single electronic device for replay anywhere at desired time. For example, a user can store a novel, a collection of poems, technical books, shows, etc. in an electronic device in a form of digital contents.

During browsing of the stored digital content in a current scheme, a user can only navigate the content only in a preset unit basis or a chapter unit basis, etc. Thus, there is a need to improve the ways to navigate to a desired content with less interaction in order to enhance user's experience.

### SUMMARY

An aspect of the present invention is to substantially solve at least the above problems and/or disadvantages and provides additional advantages, by providing an apparatus and method capable of changing a page count depending on a duration a touch input being held and moving to a desired page without frequent interactions by the user.

Another aspect of the present invention is to provide an apparatus and method capable of allowing a user to visually confirm a page count by displaying the page count in a preset region on the screen and varying the rate of page count according to predetermined criteria.

A further aspect of the present invention is to provide a user-friendly apparatus and method capable of allowing a user to set a rate of counting rate according to user's preference.

According to one aspect of the present invention, a method for navigating content of an electronic device having a touch screen includes: receiving a touch input on a particular location of the touch screen displaying the content; changing a page count to a desired page at a predefined rate according to a duration of the touch input on the touch screen; displaying the desired page in response to termination of the touch input; and determining a gesture indicative of turning a page after the page count has stopped.

According to another aspect of the present invention, an electronic device includes: a touch screen for receiving a touch input on a particular location thereon and changing a page count to a desired page at a predefined rate based on a duration of the touch input; and a processor for controlling the touch screen to display the desired page in response to termination of the touch input and to detect a further gesture indicative of turning a page after the page count has stopped.

### BRIEF DESCRIPTION OF THE DRAWINGS

The above features and advantages of the present invention will become more apparent from the following detailed description when taken in conjunction with the accompanying drawings in which:

FIG. 1 is a diagram illustrating a method for moving a page number of contents depending on a duration if input touch according to the present invention;

FIG. 2 is a diagram illustrating another exemplary embodiment of counting and displaying a page count depending on the duration of a touch input according to the present invention;

FIG. 3 is a diagram illustrating an exemplary embodiment of minutely adjusting a page number according to the present invention;

FIG. 4 is a graph illustrating an exemplary embodiment of an increasing rate according to the present invention;

FIG. 5 is a graph illustrating another exemplary embodiment of an increasing rate according to the present invention;

FIG. 6 is a graph illustrating a further exemplary embodiment of an increasing rate according to the present invention;

FIG. 7A and 7B is a diagram illustrating an exemplary embodiment of determining a gesture indicative of turning page according to the present invention;

FIG. 8A and 8B is a diagram illustrating an exemplary embodiment of determining a touch input indicative of turning page according to the present invention;

FIG. 9 is a flowchart illustrating an operation method of an electronic device according to an exemplary embodiment of the present invention; and

FIG. 10 is a block diagram illustrating a construction of an electronic device according to an exemplary embodiment of the present invention.

### DETAILED DESCRIPTION

Hereinafter, preferred embodiments of the present invention will be described herein below with reference to the accompanying drawings. For the purposes of clarity and simplicity, well-known functions or constructions are not described in detail as they would obscure the invention in unnecessary detail. Note that terms described below, which are defined considering functions in the present invention, can be different depending on user and operator's intention or practice. Therefore, the terms should be defined on the basis of the disclosure throughout this specification.

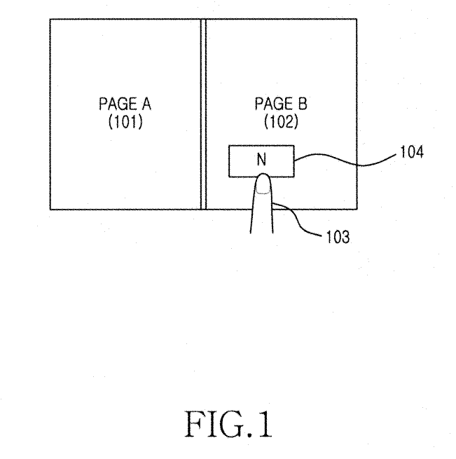

FIG. 1 is a diagram illustrating an operation of moving or changing a page count to a desired content depending on the duration of a touch input according to the present invention.

As illustrated in FIG. 1, when an electronic device executes its stored content or display content received from an exterior source, the electronic device displays a page A 101 and a page B 102 on a touch screen. In detail, if the electronic device is substantially configured in a landscape orientation, the electronic device can display a text, an image, etc., on the respective page of the touch screen. If the electronic device is substantially configured in a portrait orientation, the electronic device can display the content at one page at a time on the touch screen.

When electronic device receives a touch input at any region of the page A 101 and the page B 102 that are currently displayed by an input means 103, a fingertip or a stylus pen, the contacted area displays a page display window

Next, if the electronic device senses that it receives from the input means 103, the electronic device determines the touch duration and then changes the page count corresponding to the touch duration for a display in in a set region 104. For example, if the electronic device according to the present invention senses that it receives a touch input of any region of the page B 102 displayed on the touch screen, the electronic device counts a page number to be moved from the current page, i.e., the page B 102, and displays the page number that is being counted in the set region 104 while the touch duration is occurring.

The conventional electronic device had a problem that a user has no choice but to move a page of contents in a set unit at a certain page interval or a chapter interval and the like, the user has to move a page number repetitiously to arrive near the desired content and then turn the page one by one until the desired content is reached. However, the electronic device of the present invention has an advantage that, the user can select a desired page number by selectively varying the duration of touch contact on the screen and arrive near or at the desired page, thus minimizing user's interaction.

Here, the set time refers to a time representing the relationship of an increase/decrease of a page number dependent on a touch holding duration. Accordingly, the user can vary the rate of page changes on the set region 104 according to predetermined criteria. For instance, if a page number to be moved dependent on a touch holding duration is set linearly, the electronic device can linearly increase/decrease the page number to be moved in proportion to a touch input duration by the input means 103. That is, the electronic device can move the page number to be moved as many as Y (Y=X) pages, whenever the touch input duration increases by X seconds. Alternatively, if it is set that an increasing rate of the page number to be moved increases as the touch holding time increases, the electronic device can move the page number to be moved as many as X^{N} pages, whenever the touch input time increases by X seconds. Alternatively, if it is set that the increasing rate of the page number to be moved decreases as the touch holding time increases, the electronic device can move the page number to be moved as many as

$${X}^{\frac{1}{N}}$$

pages, whenever the touch input time increases by X seconds. That is, the electronic device of the present invention can move a page as many as X^{N} or

$${X}^{\frac{1}{N}}$$

pages, when sensing that the touch input time increase by X seconds. Here, the ‘N’ is an integer larger than ‘0’. If the user wants to go back to previous page, the user can touch the page A 101 so counting the page down. As illustrated in FIG. 1, if the user wants to go forward page, the 10 user can touch the page B 102 so counting the page up.

Thereafter, the electronic device determines whether the touch contact has ended which in turn causes the page count to stop. Then, the content is changed or turned to the page corresponding to final page count displayed after the touch contact was lifted from the screen.

In an alternate embodiment, the electronic device according to the present invention can determine that the input means 103 has been dragged to a particular region in a state of receiving the touch input from the input means 103 and increase the page count rate based on an amount of drag motion. Here, the rate of page count can be varied according to predetermined criteria discussed earlier. Similarly, the page count can be increased or decreased according to the direction of drag motion detected on the screen.

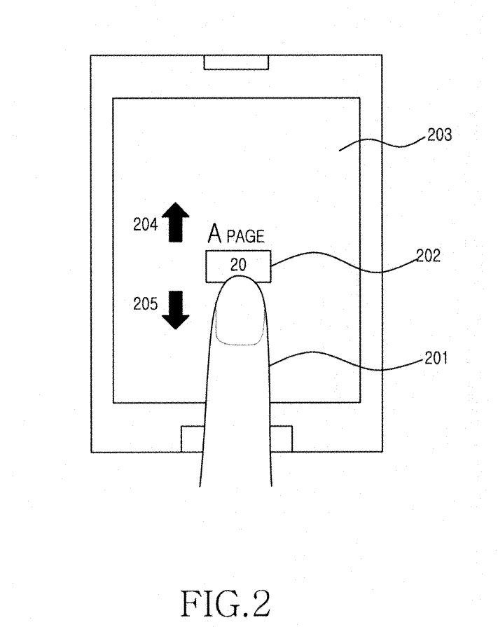

FIG. 2 is a diagram illustrating another exemplary embodiment of counting and displaying a page count according to the present invention.

As illustrated in FIG. 2, if an electronic device senses a touch input by an input means 201 on or a near the touch screen 203, the page count changes sequentially according to the duration of the touch input. For example, if the electronic device senses a gesture moving across the screen in a certain direction, the electronic device moves the page one by one according to each gesture made by the input means 201 and the direction of the moving gesture 204 or 205. Thus, the page or the content can be moved either forward or backward based on the moving hand gesture. The rate of changing page count can be preprogrammed according to predetermined criteria as discussed earlier.

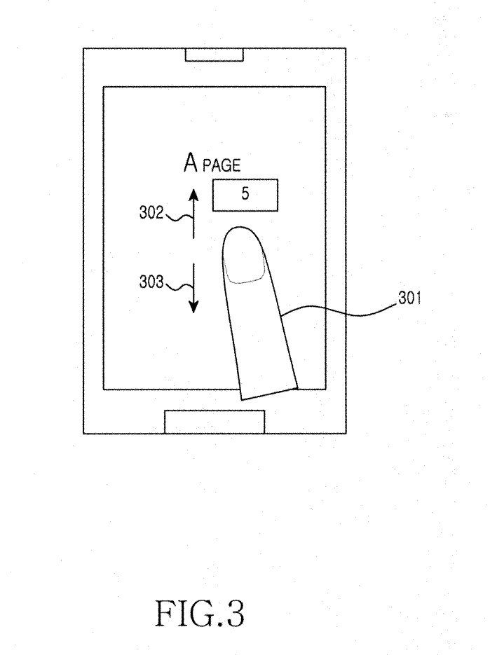

Next, when the user reaches the page count to a desired page, the user removes the contact from the screen and the desired page is displayed. The display of the page count where it stopped can be displayed on the screen or may not be displayed. Thereafter, the electronic device determines for any further input or gesture within a set time period. Then, the page is turned one by one according to the detected gesture, as shown in FIG. 3. For example, if the electronic device senses a gesture moving across the screen in a certain direction, the electronic device moves the page one by one according to each gesture made by the input means 301 and the direction of the moving gesture 302 or 303. Thus, the page or the content can be moved either forward or backward based on the moving hand gesture.

The aforementioned exemplary embodiment has been made in which the 1st region 302 is set upside and the 2nd region 303 is set downside. However, it is can be appreciated that the 1st region 302 may be set downside and the 2nd region 303 may be set upside, or the 1st region 302 may be set to the right or left and the 2nd region 303 may be set to the left or right not to overlap with the 1st region.

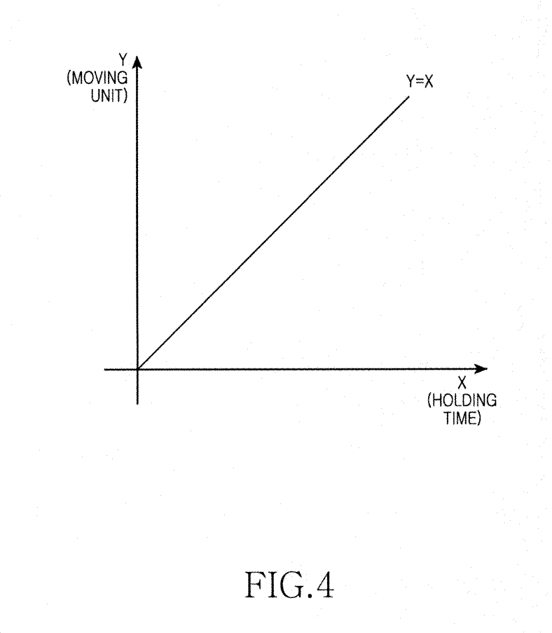

FIG. 4 is a graphical illustration of increasing page count rate based on a holding duration according to the present invention.

As shown, the set time can be defined as a time representing the relationship of a moving unit dependent on a holding duration. In detail, the set time refers to a time representing the relationship of an increase/decrease of a page count based on a touch holding time.

Assume that a result of checking the set time in the electronic device is given as in Equation 1 below.

Y=X (1)

In Equation 1 above, the ‘Y’ denotes a moving unit, and the ‘X’ denotes a holding time.

In detail, if a page count to increase or decrease dependent on a touch holding time is set linearly, the electronic device can linearly increase/decrease the page number to be moved in proportion to a touch input time of an input means. That is, the electronic device can move the page number to be moved as many as Y (Y=X) pages, whenever it increases by X seconds. For instance, assume that the electronic device is set to count a page number as many as 1 page whenever the touch input time increases by 1 second. Thus, if the electronic device receives a touch input of any region from the input means, the electronic device can move a page number by 1 page whenever the touch input time increases by 1 second. The aforementioned set time may be set as a default value, or may be set according to a user's input.

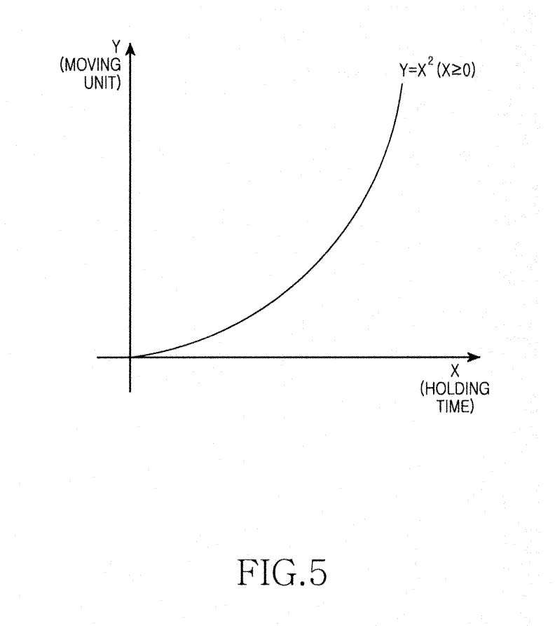

FIG. 5 is a graph illustrating another exemplary embodiment of an increasing rate of a moving unit dependent on a holding duration according to the present invention.

As illustrated in FIG. 5, assume that a result of checking the set time in the electronic device is given as in Equation 2 below.

Y=X^{N} (2)

In Equation 2 above, the ‘Y’ denotes a moving unit, and the ‘X’ denotes a holding time.

In detail, if it is set that an increasing rate of a page account increases as a touch holding time increases, the electronic device can move the page number to be moved as many as X^{N} pages, whenever a touch input time increases by X seconds. For instance, assume that the ‘N’ is equal to ‘2’, the electronic device can count a page number as many as 1, 4, 9, and 16 pages whenever the touch input time increases by 1 second. The aforementioned set time may be set as a default value, or may be set according to a user's input. Also, it is desirable that the aforementioned exemplary embodiment is set in a case where a page number that a user wishes to reach requires an extensive turning of page count.

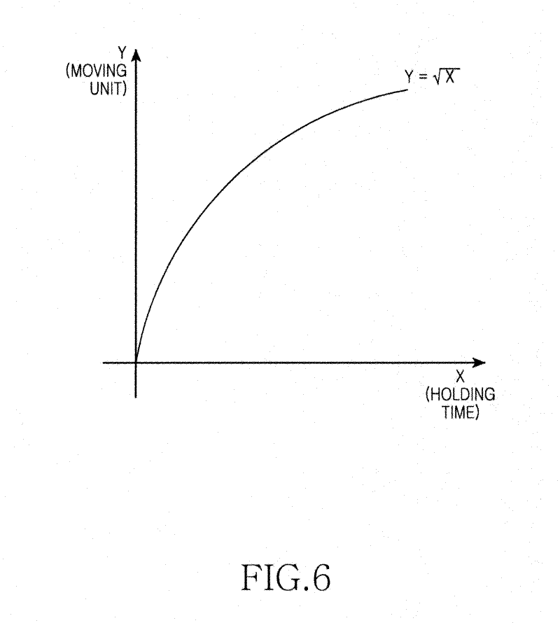

FIG. 6 is a graph illustrating a further exemplary embodiment of an increasing rate of a moving unit dependent on a holding time according to the present invention.

As illustrated in FIG. 6, assume that a result of checking the set time in the electronic device is given as in Equation 3 below.

$$Y = {X}^{\frac{1}{N}} \qquad ( 3 )$$

In Equation 3 above, the ‘Y’ denotes a moving unit, and the ‘X’ denotes a holding time.

In detail, if it is set that an increasing rate of a page count decreases as a touch holding time increases, the electronic device can move the page number to be moved as many as

$${X}^{\frac{1}{N}}$$

pages, whenever a touch input time increases by X seconds. For instance, assume that the ‘N’ is equal to ‘2’, if receiving a touch input of any region from an input means, the electronic device can move by 2 pages whenever the touch input time increases by 4 seconds. In detail, the electronic device can move 1 page when the touch input time is equal to 1 second, and move 2 pages when the touch input time is equal to 4 seconds. The aforementioned set time may be set as a default value, or may be set according to a user's input. Also, it is desirable that the aforementioned exemplary embodiment is set in a case where the whole content is small so the user wishes to slowly turn the page.

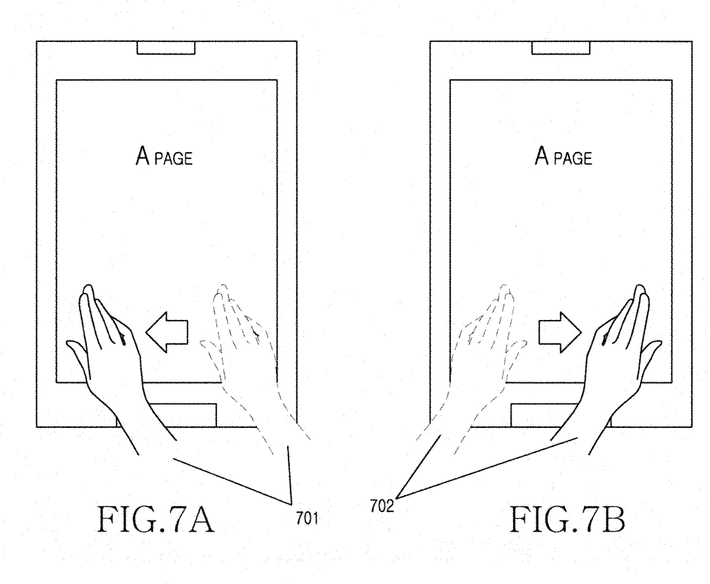

FIG. 7 is a diagram illustrating an exemplary embodiment of determining a gesture of an input means and moving the page count according to the present invention.

FIG. 7A is a diagram illustrating an exemplary embodiment of determining a gesture of an input means and moving forward according to the present invention.

First, an electronic device can determine a gesture 701 of the input means and move as many as a page number as the gesture is completed.

After the electronic device displays a page number at a desired location, the electronic device determines a 1st gesture 701 of the input means and in response moves the page to left direction.

Alternatively, the page can be moved backward according to a gesture 702, as shown in FIG. 7B.

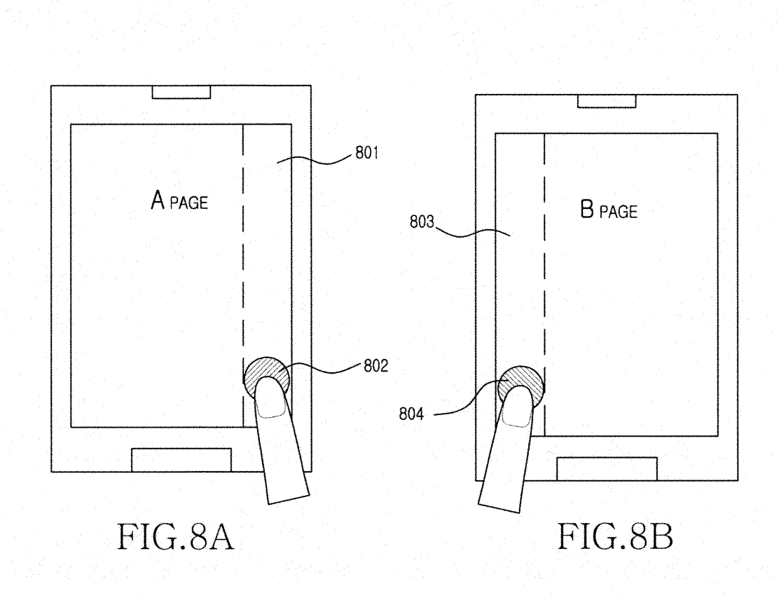

FIG. 8 is a diagram illustrating an exemplary embodiment of determining a touch input of an input means and moving a page count according to the present invention.

FIG. 8A is a diagram illustrating another exemplary embodiment of determining a touch input of an input means and moving the page according to the present invention.

First, an electronic device can determine that it has received a touch input 802 from the input means within a set region 801 and move the content forward or backward according to the drag direction of the touch input 802. Alternatively, the touch put 804 can be made on the opposite end 803, as shown in FIG. 8B.

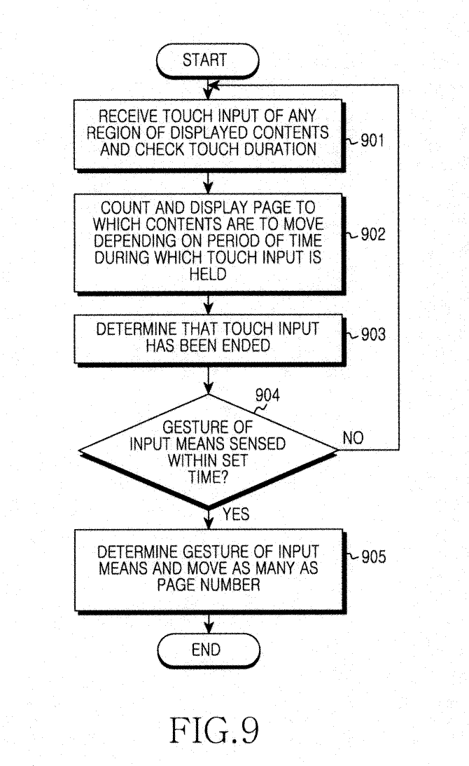

FIG. 9 is a flowchart illustrating an operation method of an electronic device according to an exemplary embodiment of the present invention.

First, in step 901, the electronic device receives a touch input at a particular region of displayed contents and checks the touch duration.

After checking the duration, in step 902, the electronic device counts and displays a desired page based on the touch duration.

In step 903, the electronic device determines that the touch input has ended. If the touch input is not ended, the electronic device does not stop counting the page number.

Next, in step 904, the electronic device determines if a gesture indicative of turning page is detected within a set time interval.

If so, in step 905, the electronic device determines the gesture and direction of gesture made, if any, and moves or turns the page as times as the detected gesture as discussed earlier.

If it is determined in step 904 that the electronic device fails to sense any gesture within the set time, the electronic device returns to step 901.

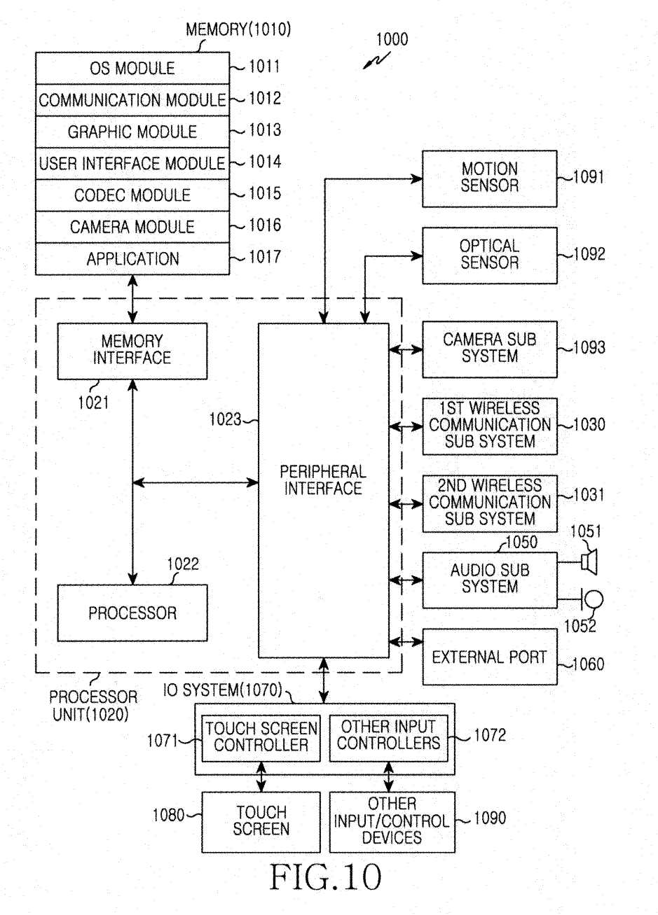

FIG. 10 is a block diagram illustrating a construction of an electronic device according to an exemplary embodiment of the present invention. The electronic device 1000 can be a portable electronic device, and can be a device such as a portable terminal, a mobile phone, a mobile pad, a media player, a tablet computer, a handheld computer, or a Personal Digital Assistant (PDA). Also, the electronic device may be any portable electronic device or duplex systems including a device combining two or more functions among these devices.

The electronic device 1000 includes a memory 1010, a processor unit 1020, a 1st wireless communication sub system 1030, a 2nd wireless communication sub system 1031, an audio sub system 1050, a speaker 1051, a microphone 1052, an external port 1060, an Input Output (10) system 1070, a touch screen 1080, and other input or control devices 1090. The memory 1010 and the external port 1060 can be used in plural.

The processor unit 1020 can include a memory interface 1021, one or more processors 1022, and a peripheral interface 1023. According to cases, the whole processor unit 1020 is also called a processor. In the present invention, the processor unit 1020 determines a gesture of an input means, moves as many as a page number of which count is completed, checks a set time, receives a touch input and concurrently checks the set time, and counts a page to which contents are to move according to the set time. Also, the processor unit 1020 determines that the touch input has been ended, stops a count, determines a set 1st gesture of an input means within the set time, and moves forward a page as many as a page number of those times at which the count is stopped from a current page. Also, the processor unit 1020 stops the count, determines a set 2nd gesture of the input means within the set time, and moves backward the page as many as the page number of those times at which the count is stopped from the current page. Also, the processor unit 1020 determines that the input means has been dragged to the set 1st region in a state of receiving the touch input, and increases the count from the page number of those times at which the count is stopped. Also, the processor unit 1020 determines that the input means has been dragged to the set 2nd region in a state of receiving the touch input, and decreases the count from the page number of those times at which the count is stopped.

The processor 1022 executes various software programs and performs various functions for the electronic device 1000 and also, performs processing and control for voice communication and data communication. Also, in addition to this general function, the processor 1022 plays even a role of executing a specific software module (i.e., an instruction set) stored in the memory 1010 and performing specific various functions corresponding to the software module. That is, the processor 1022 interworks with the software modules stored in the memory 1010 to perform a method of an exemplary embodiment of the present invention.

The processor 1022 can include one or more data processors, image processors, or COder/DECoders (CODECs). The data processor, the image processor, or the CODEC may be constructed separately. Also, the processor 1022 may be composed of several processors performing different functions. The peripheral interface 1023 connects the IO system 1070 of the electronic device 1000 and various peripheral devices thereof to the processor 1022 and connects them to the memory 1010 through the memory interface 1021.

Various constituent elements of the electronic device 1000 can be coupled with one another by one or more communication buses (not denoted by reference numerals) or stream lines (not denoted by reference numerals).

The external port 1060 is used for direct connecting a portable electronic device (not shown) to other electronic devices or indirect connecting the portable electronic device (not shown) to other electronic devices over a network (for example, the Internet, an intranet, a Wireless Local Area Network (WLAN) and the like). For example, the external port 1060 refers to, although not limited to, a Universal Serial Bus (USB) port, a FIREWIRE port or the like.

A motion sensor 1091 and an optical sensor 1092 are coupled to the peripheral interface 1023 and enable various functions. For instance, the motion sensor 1091 and the optical sensor 1092 can be coupled to the peripheral interface 1023 and sense a motion of the electronic device 1000 and sense a light from the exterior, respectively. In addition to this, a global positioning system and other sensors such as a temperature sensor, a biological sensor and the like can be coupled to the peripheral interface 1023 and perform related functions.

A camera sub system 1093 can perform a camera function such as photograph and video clip recording.

The optical sensor 1092 can use a Charged Coupled Device (CCD) device or a Complementary Metal-Oxide Semiconductor (CMOS) device.

One or more wireless communication sub systems 1030 and 1031 30 perform a communication function. The 1st wireless communication sub system 1030 and the 2nd wireless communication sub system 1031 can include a Radio Frequency (RF) receiver and transceiver and/or an optical (e g , infrared) receiver and transceiver. The 1st wireless communication sub system 1030 and the 2nd wireless communication sub system 1031 can be distinguished according to a communication network in which the electronic device 1000 communicates. For example, the communication network can include a communication sub system designed to operate through, although not limited to, a Global System for Mobile Communication (GSM) network, an Enhanced Data GSM Environment (EDGE) network, a Code Division Multiple Access (CDMA) network, a Wireless-Code Division Multiple Access (W-CDMA) network, a Long Term Evolution (LTE) network, an Orthogonal Frequency Division Multiple Access (OFDMA) network, a Wireless Fidelity (Wi-Fi) network, a Wireless interoperability for Microwave Access (WiMAX) network, a Bluetooth network or/and the like. The 1st wireless communication sub system 1030 and the 2nd wireless communication sub system 1031 may be combined and constructed as one wireless communication sub system.

The audio sub system 1050 is coupled to the speaker 1051 and the microphone 1052, and can take charge of input and output of an audio stream such as voice recognition, voice replication, digital recording, and telephony function. That is, the audio sub system 1050 communicates with a user through the speaker 1051 and the microphone 1052. The audio sub system 1050 receives a data stream through the peripheral interface 1023 of the processor unit 1020, converts the received data stream into an electric stream, and forwards the converted electric stream (i.e., electric signal) to the speaker 1051. The speaker 1051 converts the electric stream into human-audible sound waves and outputs the converted sound waves. The microphone 1052 converts sound waves forwarded from human or other sound sources into electric streams. The audio sub system 1050 receives the converted electric streams from the microphone 1052. The audio sub system 1050 converts the received electric streams into audio data streams, and transmits the converted audio data streams to the peripheral interface 1023. The audio sub system 1050 can include a detachable earphone, headphone or headset.

The IO system 1070 includes a touch screen controller 1071 and/or other input controller 1072. The touch screen controller 1071 can be coupled to the touch screen 1080. The touch screen 1080 and the touch screen controller 1071 can detect a contact and a motion or an interruption thereof by using, although not limited to, not only capacitive, resistive, infrared and surface acoustic wave technologies for determining one or more contact points with the touch screen 1080 but also any multi-touch sensing technology including other proximity sensor arrays or other elements. The other input controller 1072 can be coupled to the other input/control devices 1090. The other input/control devices 1090 can be at least one or more buttons, a rocker switch, a thumb-wheel, a dial, a stick, a pointer device such as a stylus, and/or the like.

The touch screen 1080 provides an input/output interface between the electronic device 1000 and a user. That is, the touch screen 1080 forwards a user's touch input to the electronic device 1000. Also, the touch screen 1080 is a medium for showing an output of the electronic device 1000 to the user. That is, the touch screen 1080 shows a visual output to the user. This visual output can be presented in a form of a text, a graphic, a video, and a combination thereof.

The touch screen 1080 can use various displays. For example, the touch screen 1080 can use, although not limited to, a Liquid Crystal Display (LCD), a Light Emitting Diode (LED), a Light emitting Polymer Display (LPD), an Organic Light Emitting Diode (OLED), an Active Matrix Organic Light Emitting Diode (AMOLED), or a Flexible LED (FLED). In the present invention, the touch screen 1080 receives a touch input of any region of displayed contents, and counts and displays a page to which the contents are to move depending on a period of time at which the touch input is held. Also, the touch screen 1080 displays the page that is being counted in a set region, displays a page number of those times at which the count is stopped during the set time, and displays the page number of those times at which the count is stopped during the set time.

The memory 1010 can be coupled to the memory interface 1021. The memory 1010 can include one or more high-speed random access memories and/or non-volatile memories such as magnetic disk storage devices, one or more optical storage devices and/or flash memories (for example, Not AND (NAND) memories, Not OR (NOR) memories).

The memory 1010 stores software. A software constituent element includes an Operating System (OS) module 1011, a communication module 1012, a graphic module 1013, a user interface module 1014, an MPEG module 1015, a camera module 1016, one or more application modules 1017 and the like. Also, because the modules, which are the software constituent elements, can be expressed as a set of instructions, the module is also called an instruction set. The module is also called a program. The OS software 1011 (for instance, a built-in operating system such as WINDOWS, LINUX, Darwin, RTXC, UNIX, OS X, or VxWorks) includes various software constituent elements controlling general system operation. Control of the general system operation represents, for example, memory management and control, storage hardware (device) control and management, power control and management and the like. The OS software 1011 performs even a function of making smooth communication between various hardware (devices) and software constituent elements (modules).

The communication module 1012 can enable communication with other electronic device such as a personal computer, a server, a portable terminal and/or the like, through the 1st and 2nd wireless communication sub systems 1030 and 1031 or the external port 1060.

The graphic module 1013 includes various software constituent elements for providing and displaying a graphic on the touch screen 1080. The term ‘graphic’ is used as meaning including a text, a web page, an icon, a digital image, a video, an animation and the like. In the present invention, the touch screen 1080 displays a message on setting or non-setting of a smart rotation function, and receives a selection of any region included in the message.

The user interface module 1014 includes various software constituent elements associated with a user interface. The user interface module 1014 includes information about how a state of the user interface is changed and in which conditions the state of the user interface is changed, and the like.

The CODEC module 1015 can include a software constituent element related to encoding and decoding of a video file. The CODEC module 1015 can include a video stream module such as an MPEG module and/or H204 module. Also, the CODEC module 1015 can include several audio file CODEC modules such as AAA, AMR, WMA and the like. Also, the CODEC module 1015 includes an instruction set corresponding to an implementation method of the present invention.

The camera module 1016 includes a camera related software constituent element enabling camera-related processes and functions.

The application module 1017 includes a browser, an electronic mail (e-mail), an instant message, word processing, keyboard emulation, an address book, a touch list, a widget, Digital Right Management (DRM), voice recognition, voice replication, a position determining function, a location-based service and the like.

The above-described embodiments of the present disclosure can be implemented in hardware, firmware or via the execution of software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

As described above, an electronic device and method for moving a page number of contents depending on a touch time according to the present invention can determine and reach a desired page based on the touch duration detected on the screen, thus minimizing user's frequent interaction.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for navigating content of an electronic device having a touch screen, the method comprising:
receiving a touch input on a particular location of the touch screen displaying the content;
changing a page count to a desired page at a predefined rate according to a duration of the touch input on the touch screen; and
displaying the desired page in response to termination of the touch input.

2. The method of claim 1, further comprising determining a gesture indicative of turning a page within a predetermined time period.

3. The method of claim 1, wherein the content includes at least three pages.

4. The method of claim 1, further comprising displaying the page count in a predefined region of the touch screen.

5. The method of claim 1, further comprising displaying the page count in the predetermined region of the touch screen upon receipt of the touch input.

6. The method of claim 2, wherein determining the gesture comprises:
turning the page forward or backward in response the determined gesture.

7. The method of claim 1, further comprising:
stopping the page count in response to termination of the touch input; and
displaying the stopped page count.

8. The method of claim 2, wherein determining the gesture comprises:
turning the page forward in sequence in response to the determined gesture detected in a first direction.

9. The method of claim 2, wherein determining the gesture comprises:
turning the page backward in sequence in response to the determined gesture detected in a second direction.

10. An electronic device comprising:
a touch screen for receiving a touch input on a particular location thereon and changing a page count to a desired page at a predefined rate based on a duration of the touch input; and
a processor for controlling the touch screen to display the desired page in response to termination of the touch input.

11. The device of claim 10, wherein the processor is further configured to detect a gesture indicative of turning a page after the page count has stopped.

12. The device of claim 10, wherein the content includes at least three pages.

13. The device of claim 10, wherein the processor controls the touch screen to display the page count in a predefined region thereon.

14. The device of claim 10, wherein the processor further controls the touch screen to display the page count in the predetermined region of the touch screen upon receipt of the touch input.

15. The device of claim 11, wherein
the processor further controls the touch screen to display the page count in the predetermined region of the touch screen upon receipt of the touch input.

16. The device of claim 10, wherein the processor further controls stopping the page count in response to termination of the touch input and display the stopped page count.

17. The device of claim 11, wherein the processor further controls the touch screen to turn the page forward or backward in response the detected gesture.

18. The device of claim 11, the processor further controls the touch screen to turn the page forward in sequence in response to the detected gesture moving in a first direction.

19. The device of claim 10, the processor further controls the touch screen to turn the page backward in sequence in response to the moving gesture detected in a second direction.
